(19) United States
(12) Patent Application Publication
(10) Pub. No.: US 2025/0338031 A1
(43) Pub. Date: Oct. 30, 2025

(54) LIGHT DETECTION THROUGH ENHANCED ELECTRON EMISSION

(71) Applicant: Massachusetts Institute of Technology, Cambridge, MA (US)

(72) Inventors: Karl K. BERGGREN, Cambridge, MA (US); Phillip Donald KEATHLEY, Cambridge, MA (US); Ilya PRIGOZHIN, Cambridge, MA (US); Kevin Kyungbum RYU, Cambridge, MA (US); Matthew YEUNG, Cambridge, MA (US)

(73) Assignee: Massachusetts Institute of Technology, Cambridge, MA (US)

(21) Appl. No.: 19/190,083

(22) Filed: Apr. 25, 2025

Related U.S. Application Data
(60) Provisional application No. 63/639,507, filed on Apr. 26, 2024.

(51) Int. Cl. H04N 25/17; H01J 3/02

(52) U.S. Cl. CPC H04N 25/17; H01J 3/024

(57) ABSTRACT

A device for converting light into an electron current emission is described. The device includes a substrate having first and second opposing surfaces. At least one antenna is disposed on the substrate. The at least one antenna is configured to absorb energy from photons having a selected wavelength. At least one dimension of the at least one antenna is a resonant length based on the selected wavelength. In response to photons incident thereon, at least a portion of the at least one antenna is heated to a degree which results in a thermionic emission from the antenna. The device also include at least one collector spaced apart from the at least one antenna by a selected distance. The at least one collector is configured to receive a Schottky emission from the at least one antenna. The received Schottky emissions may be used to signal a photon detection.

### CROSS-REFERENCE TO RELATED APPLICATIONS

This application is a U.S. Nonprovisional application which claims the benefit of U.S. Provisional Application No. 63/639,507, filed Apr. 26, 2024, and is hereby incorporated by reference in its entirety.

### STATEMENT REGARDING FEDERALLY SPONSORED RESEARCH

Not Applicable.

### BACKGROUND

Mid-wave and long-wave infrared (MWIR and LWIR, respectively) wavelengths are used in a number of light detection applications such as surveillance, communications, and night vision. Traditional detectors such as mercury cadmium telluride (HgCdTe) and strained-layer superlattice (SLS) photon detectors require cryogenic cooling and thus have size, weight, and power (SWaP) requirements which are not suitable for some applications. While uncooled sensors such as microbolometers do not require cryogenic cooling such detectors have limited sensitivity and/or slow response times compared with the sensitivity and response times of HgCdTe and SL S) photon detectors.

### SUMMARY

The below summary is merely representative and non-limiting.

The above size, weight, and power (SWaP) challenges and sensitivity and/or response time drawbacks of prior art approaches are overcome, and other advantages may be realized, by the use of the concepts and embodiments described herein. Various concepts and embodiments described herein provide highly sensitive light detectors which function at room temperature. Systems and devices provided in accordance with the concepts described herein avoid the size, weight, and power (SWaP) challenges of conventional systems while providing a level of sensitivity and response times suitable for a number of different light detection applications including, but not limited, surveillance, communications, and night vision.

In a first aspect, an embodiment provides a device for converting light into an electron current emission. The device includes a substrate having first and second opposing surfaces. An antenna is disposed on the substrate. The antenna is configured to absorb energy from photons having a selected wavelength. A dimension of the antenna is a resonant length based on the selected wavelength. In response to photons incident thereon, a portion of the antenna is heated to a degree which results in a thermionic emission from the antenna. The device also includes a collector spaced apart from the at least one antenna by a selected distance. The collector is configured to receive thermionic emissions (e.g., a Schottky emissions) from the antenna. The received Schottky emissions may be used to signal a photon detection.

In another aspect, an embodiment provides a device for converting light into an electron current emission. The device includes a substrate having first and second opposing surfaces. The device also includes at least one antenna disposed on the substrate. The at least one antenna is configured to absorb energy from photons having a selected wavelength. At least one dimension of the at least one antenna is a resonant length based on the selected wavelength. In response to photons incident thereon at least a portion of the at least one antenna is heated to a degree which results in a thermionic emission from the at least one antenna. The device also includes at least one collector spaced apart from the at least one antenna by a selected distance. The at least one collector is configured to receive a Schottky emission from the at least one antenna.

In a further embodiment of the device above, the device also includes an output configured to produce a signal in response to the at least one collector receiving the thermionic emission.

In an additional embodiment of the device above, the thermionic emission is a Schottky emission.

In a further embodiment of the device above, at least one of the at least one antenna has a shape corresponding to (a) a rectangular shape; (b) a square shape; (c) a triangular shape; or (d) a diabolo shape.

In an additional embodiment of the device above, at least one of the at least one collectors has a shape corresponding to (a) a rectangular shape; (b) a square shape; (c) a triangular shape; (d) a saw tooth shape; or (e) a diabolo shape.

In a further embodiment of the device above, the shape of at least one antenna matches the shape of at least one collector.

In an additional embodiment of the device above, the at least one antenna is provided as an array of antennas with each antenna of the array of antennas coupled to one collector.

In a further embodiment of the device above, the at least one collector is provided as an array of collectors.

In an additional embodiment of the device above, the at least one antenna is provided as an array of antennas; the at least one collector is provided as an array of collectors; and each antenna of the array of antennas is coupled to a corresponding antenna of the array of antennas.

In a further embodiment of the device above, the portion of the at least one antenna which is heated occurs at an apex region of the at least one antenna.

In an additional embodiment of the device above, the at least one antenna has a diabolo shape and the portion of the at least one antenna which is heated occurs at a bar region of the diabolo-shaped antenna.

In a further embodiment of the device above, the at least one antenna and at least one collector include materials selected to reduce a thermal conductance characteristic between the at least one antenna and the substrate.

In an additional embodiment of the device above, the at least one antenna and/or the at least one collector are disposed on the substrate such that at least a portion of at least one of the antenna and collector is partially or wholly suspended so as to prevent thermal conductivity between the at least one antenna and the underlying substrate.

In a further aspect, an embodiment provides sensor system. The sensor system includes a device for converting light into an electron current emission. The device includes a substrate having first and second opposing surfaces. The device also includes at least one antenna disposed on the substrate. The at least one antenna is configured to absorb energy from photons having a selected wavelength. At least one dimension of the at least one antenna is a resonant length based on the selected wavelength. In response to photons incident thereon, at least a portion of the at least one antenna is heated to a degree which results in a thermionic emission from the antenna. The device also includes at least one collector spaced apart from the at least one antenna by a selected distance. The at least one collector is configured to receive a Schottky emission from the at least one antenna and generate the electron current emission. The sensor system also includes a processor configured to receive the electron current emission and generate an output signal; and an output device configured to produce an image based on the output signal.

In an additional embodiment of the sensor system above, the device for converting light into an electron current emission is partially or wholly suspended so as to prevent thermal conductivity between the at least one antenna and the underlying substrate.

In a further embodiment of the sensor system above, when generating the output signal, the processor is configured to generate a pixel based on the electron current emission received from the device for converting light into an electron current emission.

In an additional embodiment of the sensor system above, the processor is configured to receive the electron current emission from a plurality of devices for converting light into an electron current emission.

In another aspect, an embodiment provides a method for generating an optical image pixel. The method includes resonantly collecting optical energy in an antenna configured to absorb energy from photons having a desired wavelength. A resonant dimension of the antenna is a resonant length based on the desired wavelength. The resonant dimension is configured to cause the energy absorbed to heat a heated portion of the antenna and cause the antenna to emit a Schottky emission. The optical energy produces carrier heating at the heated portion. The method also includes emitting Schottky electrons from the heated portion of the antenna due in part by the carrier heating. The Schottky electrons are received at a collector separated from the antenna by a vacuum gap to produce an optical signal. The method also includes generating an optical image pixel based on the optical signal.

### BRIEF DESCRIPTION OF THE DRAWINGS

The foregoing features may be more fully understood from the following description of the drawings in which various aspects of the concepts and embodiments described herein are described. It should be appreciated the figures are not necessarily drawn to scale. In the drawings, each identical or nearly identical component that is illustrated in various figures is represented by a like numeral. For purposes of clarity, not every component may be labeled in every drawing.

FIG. 1 is a schematic of triangular antenna with wire collector.

FIG. 2 shows a scanning electron microscope image of a nanoantenna array.

FIG. 3 demonstrates tunable absorption through changing geometry.

FIG. 4 illustrates biased-induced electron emission regimes into vacuum from metallic nano-vacuum devices.

FIG. 5 illustrates optical excitation in Schottky emission regimes.

FIG. 6 demonstrates a biased nanoantenna arrays for light detection.

FIG. 7 shows the gap between an antenna and collector.

FIG. 8 is a block diagram of a detection system comprising a detector provided in accordance with the concepts described herein.

FIG. 9A is an exploded isometric view of a digital focal plane array (DFPA) comprising an array of detectors provided in accordance with the concepts described herein disposed over a readout integrated circuit (ROIC).

FIG. 9B is an enlarged top view of a portion of the detector array in the DFPA of FIG. 9A.

FIG. 9C is an enlarged view of an antenna and collector in the detector array of FIG. 9B.

FIG. 10A is a top view of an alternate embodiment of an antenna-collector arrangement suitable for use in the DFPA of FIG. 9A.

FIG. 10B is a cross-sectional view taken along line A-A of FIG. 10A of the antenna-collector arrangement of FIG. 10A.

FIG. 10C is a cross-sectional view of an alternate embodiment of an antenna-collector arrangement suitable for use in the DFPA of FIG. 9A and illustrating an air bridge.

FIG. 11 is a cross-sectional view of an alternate embodiment of an antenna-collector arrangement having illustrating an antenna-collector arrangement suitable for use in the DFPA of FIG. 9A with the antenna and collector disposed on opposing surfaces of a substrate.

FIGS. 12-15B demonstrate various antenna-collector designs suitable for use in the DFPA of FIG. 9A.

FIG. 16 is a schematic diagram of a device for light detection in accordance with an embodiment.

FIG. 17 illustrates the impact of a bias voltage to the antenna of FIG. 16.

FIG. 18 a block diagram of a general-purpose computer which processes computer programs using a processing system.

FIG. 19 is a flow diagram that illustrates the operation of a method, and a result of execution of computer program instructions embodied on a computer readable memory, in accordance with various embodiments.

### DETAILED DESCRIPTION

Various embodiments described herein provide devices having light detectivities that potentially exceed bolometric-based detectors by several orders of magnitude at room temperature. Such devices include an IR detector capable of operating at room temperature that is compact, high-speed, polarization-sensitive, and spectrally tunable through geometric patterning.

Infrared detection at room temperature, such as InfraRed-Enhanced Electron Emission from Nanoantennas (IREEN), can operate by using resonant metallic nanostructures coupled with nanoscale gaps for electron emission. IREEN offers a viable alternative to IR detection that is both scalable and simple to fabricate using standard CM OS processing.

InfraRed-Enhanced Electron Emission from Nanoantennas (IREEN) systems operate under a principle involving two key components for light detection. The first is a coupling of the optical electric field to resonant nanoantenna structures. The resonant coupling and confinement of the incoming energy results in a significant optical field enhancement and thermal heating in the structure. The second component is the emission of electrons through a nanoscale vacuum gap between the absorbing nanoantenna and a collection structure. The strong fields and heating from the photon absorption process cause a nonlinear increase in the baseline carrier emission rate through the nanoscale gap.

Various embodiments use IREEN to detect infrared light at room temperature. Such devices use resonant nanostructures and nanoscale vacuum emission channels designed to be sensitive to select IR frequency bands. This approach can also be translated to other wavelengths of interest in addition to MWIR wavelengths (3-5 μm), for example, near-IR and visible light wavelengths.

Using IREEN offers an opportunity to improve the performance of room-temperature IR detectors while also lowering the fabrication cost and enabling spectral selectivity and high-speed operation. IREEN enables detectivities approaching or exceeding 10¹⁰ Jones with response times on the order of nanoseconds or less.

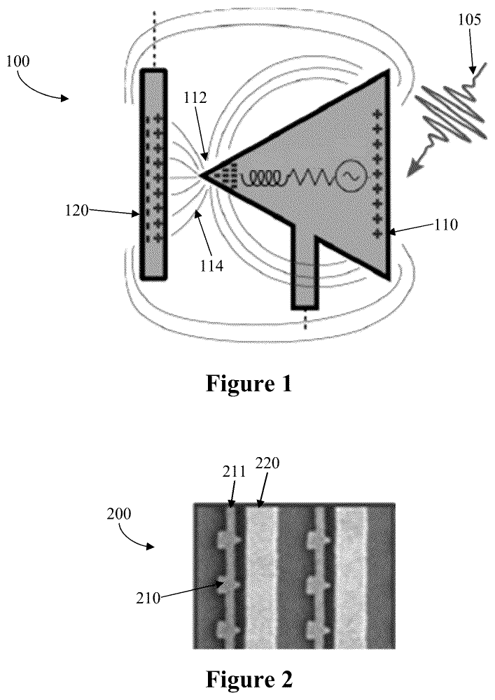

FIG. 1 is a schematic of triangular antenna with wire collector suitable for IREEN devices. When illuminated by an optical pulse 105, the charges in the antenna 110 separate by polarity and slosh back and forth through the resistive and inductive body of the antenna 110. The charge separation creates electric fields. The optical excitation is mapped to a voltage source displacing charges, the electric fields due to charge separation are mapped to voltages across capacitors, and the emission current is mapped to a current source. Electrons in the antenna 110 collect at the apex 112 and may cross the gap 114 to be absorbed in collector 120, for example, due to Schottky emission.

Multiple antennas, such as antenna 110, may be connected in an array. FIG. 2 shows a scanning electron microscope image 200 of a nanoantenna array. The array includes multiple antennas 210 connected by conductor 210. As shown, apexes of the antennas 210 are disposed near a single collector 220. In other embodiments, each antenna 210 may have an individual associated collector.

In some embodiments, electrically connected antennas, such as antenna 110 and antenna 210, are arrayed and separated from a metallic collector structure by an air or vacuum channel. This channel (or gap) may be on the order of 10 nm. A bias voltage applied across the gap drives the antennas into either the Schottky and/or cold-field emission regimes resulting in a baseline current emission rate. Due to the narrow gaps, large field strengths can be achieved with small biasing voltages. This significantly reduces the size and power needed to operate the devices compared to conventional vacuum electronics. Incoming radiation, absorbed by the antenna structure, changes this baseline emission rate and provides photodetection.

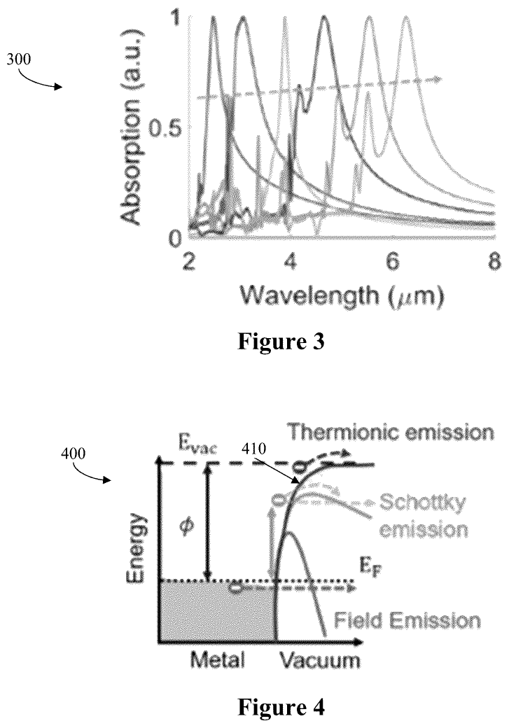

FIG. 3 demonstrates tunable absorption through changing geometry. This demonstrates that peak absorption can be tuned through the entire MWIR spectral region and beyond. As shown, larger antennas (e.g., those having larger widths) are able to absorb larger wavelengths. Accordingly, the size of the antenna may be selected in order to tune the device for a given wavelength.

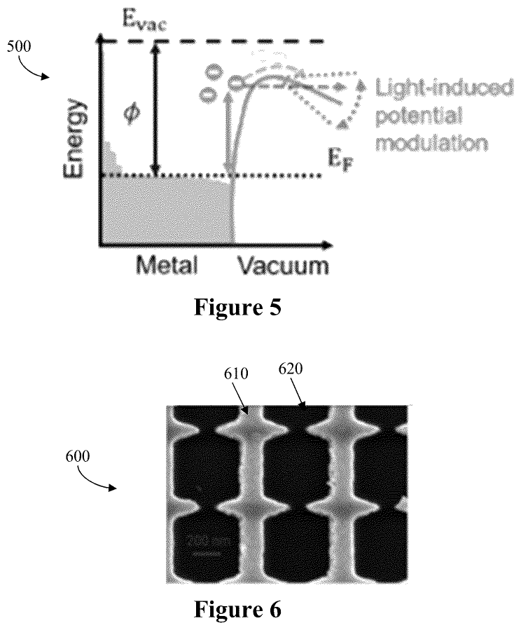

FIG. 4 illustrates biased-induced electron emission regimes into vacuum from metallic nano-vacuum devices and FIG. 5 illustrates optical excitation in a Schottky emission regime 500. With no optical excitation, there is the possibility of thermionic emission where electrons with enough thermal energy escape the barrier 410. A Schottky emission results from field-assisted thermionic emission, and field emissions result from the direct tunneling of electrons due to barrier thinning from the applied field.

Optical excitation results in oscillating surface fields as well as nonequilibrium electron excitation and time-averaged heating of the emitter structure which alter the ground state energy distribution. These effects can result in Schottky emissions.

IREEN devices similar to those shown in FIG. 2 enable new capabilities in optical detection that exploit the enhanced optical absorption and local electric fields provided by the nanoscale structures. For ultrafast optical detection, IREEN devices can detect femtosecond near-IR laser pulses down to the femto- to picojoule level through optical-field-driven tunneling. These devices demonstrate electron emission rates approaching the PHz-scale (10¹⁵ Hz) and sensitivity to the carrier-envelope-phase under ambient conditions.

FIG. 6 demonstrates a biased nanoantenna arrays 610 for light detection. In the infrared spectral region, IREEN devices 600 with nanoscale air channels 620 like those shown in FIG. 6 may be used for the detection of MWIR and LWIR light. Detectivities similar to that of microbolometers can be observed when the devices are excited with an incoherent infrared source (6×10⁸ J ones, optimized for operation at 12 μm).

This Schottky emission process contributes to the device's sensitivity under incoherent/continuous wave (CW) excitation, a regime in which the higher average power changes the dynamics of the emission process. The Schottky emission rate equation with key parameters included is shown in equation (1):

$${I}_{Schottky} ∝ {T}^{2} exp \{ \frac{- ϕ + β \sqrt{F}}{{k}_{B} T} \} \qquad ( 1 )$$

where T is temperature, F is the surface electric field, ϕ the material work function, k_{B} the Boltzmann constant, and β a constant. The emission rate is nonlinearly sensitive to the device temperature and effective work function, with the emission rate and nonlinearity controlled by the DC bias, which effectively provides internal gain.

As Schottky emission dominates with little contribution from the infrared surface field component under CW or incoherent IR illumination, an alternative emitter-collector orientation may be desirable.

Beyond detectivity, the operating mechanism of the devices also dictates their response time. While optical-field-induced emission and photon absorption effects can take place on the femtosecond scale, time-averaged heating effects are much slower. Using femtosecond pulsed excitation, IREEN devices can be coupled to transmission lines with the ability to transmit optoelectronic signals having tens of THz bandwidth across hundreds of millimeters. By comparison, emission due to time-averaged heating result in significantly slower rise times.

In various embodiments, the thermal rise times are on the order of nanoseconds for antenna volumes on the order of 10⁵-10⁶ nm³. Nonetheless, time-averaged thermal emission dominates, the expected nanosecond response times are orders of magnitude shorter than those of conventional systems.

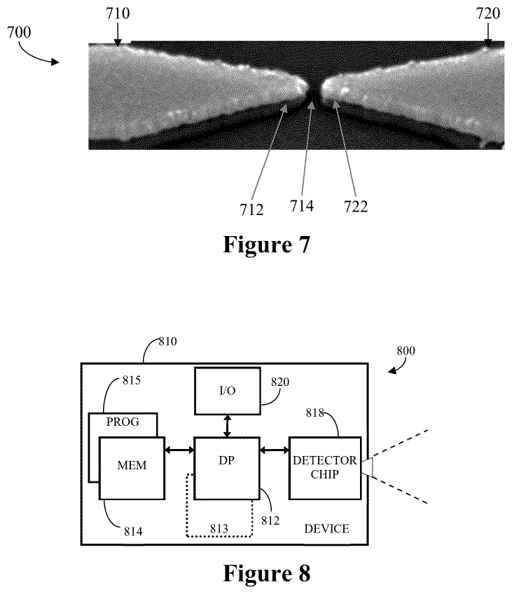

Various nanoantenna array structures may be designed for optical coupling to MWIR wavelengths. For example, a lateral patterned antenna may have a gap vacuum electronic emitter 700 such as shown in FIG. 7. The antenna 710 extends to an apex 712 which is separated from the collector 720 by a gap 714 (shown as being nineteen (19) nm). In this embodiment, the collector 720 includes a matching apex 722. The size and shape of the antenna 710 ensure that absorbed optical energy result in thermal heating at the apex 712 in order to facilitate Schottky emissions. Note that the gap in some embodiments may be larger, for example, approximately 100 nm or less.

The devices structures may be created using a variety of materials. For example, the antennas and/or collectors may be made of Au, TiN, Al, Mo, W, Nb, Pt, NiCr, Cr, Ti, and Si.

One benefit of the lateral patterning process used to fabricate such devices is that different designs may be carried out simultaneously using precision photo- or electron-beam-lithography. While some of the characterization and benchmarking of these devices has to be carried out on packaged parts in a vacuum chamber, a significant portion of the characterization can be done using automated wafer probe stations to extract current-voltage relationships with temperature control between −30° C. and +25° C. Substrate temperature can also play a role in the background leakage current. Cryogenic cooling can take advantage of these characteristics.

Referring now to FIG. 8, a system 800 includes a controller, which may be provided as, for example, one or more processors such as data processor (DP) 812. System 800 may further include a computer-readable medium embodied as a memory (MEM) 814 that stores data and/or computer instructions, such as a program (PROG) 815, and a suitable I/O interface 820, such as a display screen. System 800 also includes a light detector 818 (or more simply detector 818) to detect light as described. Details of detector 818 will be described further hereinbelow. Light detector 818 may, for example, be provided as an integrated circuit (i.e., an “IC” or “chip”). System 800 may also include and/or comprised a dedicated processor, for example graphic image generator 813 or other image processing circuitry.

The program 815 may include program instructions that, when executed by the DP 812, enable system 800 to perform various functions (e.g., surveillance, aerial search and rescue and remote sensing functions) in response to detected light. That is, various functions may be performed or implemented at least in part by computer software executable by the one or more processors of the system 800. In embodiments, some or all functions may be performed by hardware, or by a combination of software and hardware.

In general, various embodiments of the system 800 may include electronic eyewear (e.g., glasses or goggles), digital cameras, cellular telephones (e.g., so-called “smart phones”), tablets, gaming devices, as well as other devices that incorporate combinations of such functions. In embodiments, system 800 may also correspond to a surveillance system, an aerial search and rescue system and/or a remote sensing system.

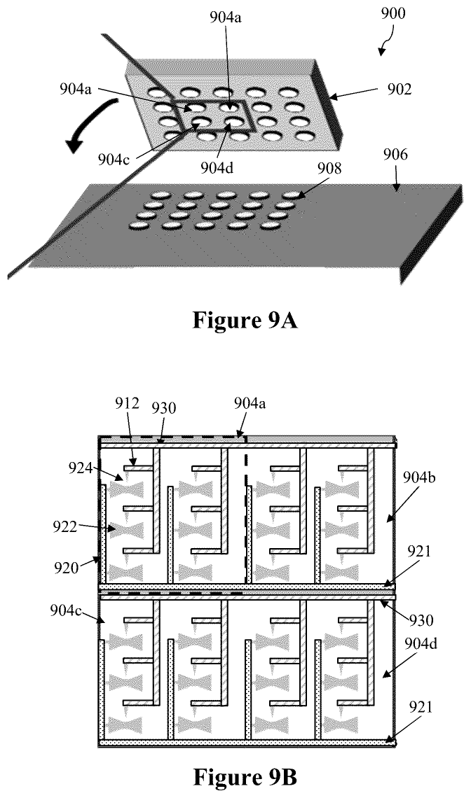

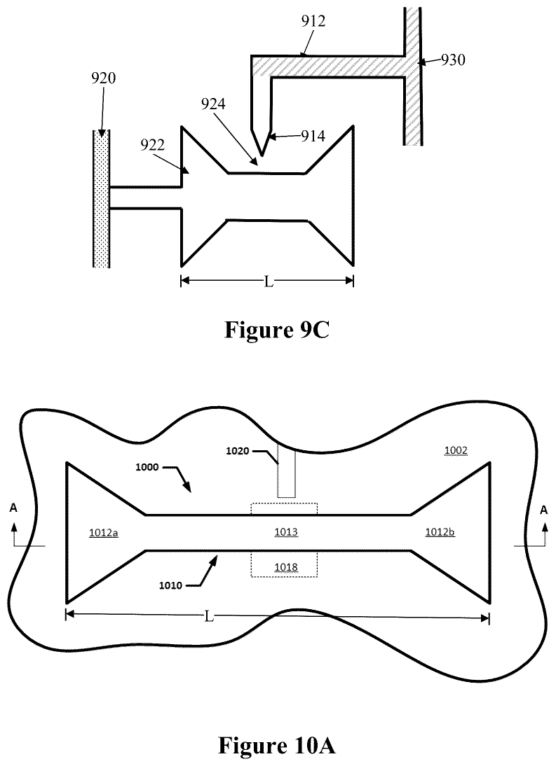

Referring now to FIGS. 9A-9C in which like elements are provided having like reference designations throughout the several views, FIG. 9A illustrates a detector 900 comprising an array of light detector elements 904 (e.g., antenna-collector elements) provided in accordance with the concepts described herein disposed. Detector 900 may, for example, be the same as or similar to detector 818 in FIG. 8. In this example embodiment, device 900 includes a detector integrated circuit (i.e., an IC or chip) 902 coupled to a read-out integrated circuit (ROIC) 906. In embodiments, ROIC 906 may be provided as a digital focal plane array (DFPA) ROIC or other type of ROIC. The detector chip 902 includes a plurality (i.e., an array) of light detector elements 904 arranged in a pattern. In this example embodiment, light detector elements 904 are arranged in a planar grid pattern. Other arrangements, may of course, also be used such as a linear array pattern. Light detector elements 904a-904d, collectively referred to as light detector elements 904, may also be arranged in a triangular pattern, a circular pattern, an oval pattern or any regular or irregular geometric pattern.

The ROIC 906 includes pads 908 (e.g., conductive pads) physically arranged and configured to communicate with light detector elements 904 to determine when the light detector elements 904 detect light. Thus, signals may be passed between detector elements 904 and ROIC 906. In this example embodiment, conductive pads 908 are arranged in a pattern which substantially matches the pattern of light detector elements 904. The detector device 900 may then provide a pixel-based output. Thus, in one embodiment, FIG. 9A illustrates an example of a digital focal plane array (DFPA) comprising an array of detectors 902 provided in accordance with the concepts described herein disposed over a readout integrated circuit (ROIC).

FIG. 9B illustrates a portion of detector array in the detector chip 902 of FIG. 9A. Taking light detector element 904a as illustrative of all light detector elements 904, light detector element 904a includes one or more antenna elements 922 (with six (6) antenna elements being shown in this example embodiment) and one or more collector elements 912 (with six (6) collector elements being shown in this example embodiment). In this example embodiment the number of collectors equals the number of antennas.

It should, of course, be appreciated that in other embodiments, the number of collectors may be different that the number of antennas (i.e., there may be fewer or more collectors than antennas. The number of collectors and antennas can differ depending on the application, for example, to provide polarization sensitivity one emitter may be located in the center of four collectors. As discussed herein, the size and shape of the antenna elements 922 causes the antenna elements 922 to heat when absorbing optical energy. The collector elements 912 are disposed in proximity to the antenna elements 922 so as to receive thermionic emissions (e.g., a Schottky emissions).

The various antenna element 922, shown here having a diabolo shape, are connected by antenna column signal paths 920. In some embodiments, the antenna column signal paths 920 may be a single, electrically connected, path to the antenna elements 922 so that the antenna elements 922 may be biased together. The antenna column signal paths 920 are coupled to a row signal path 921.

Similarly, collector elements 912 are connected by collector signal paths 930. The collector signal paths 930 are coupled to row signal paths 921. In embodiments, collector signal paths 920 may be provided conductors disposed on a substrate.

In some embodiments, the collector signal path 930 may provide separate signal path for each collector elements 912 so that each pixel subset (antenna-collector set) has an individual path within the collector signal path 930. In other embodiments, each collector elements 912 produces a current which is summed with other collector elements 912 sharing a collector signal path 930.

Row signal paths 921 provide connections for various components of the light detector element 904. As discussed above, similar components may be interconnected (e.g., to provide a shared bias to antenna elements 922) or treated separately (e.g., handling each collector element 912 individually). Row signal paths 921 may provide a connection point to allow communication with conductive pads 908. FIG. 9C is an enlarged view of an antenna element 922 and associated collector 912 in the detector chip 902 of FIG. 9B. As shown, each collector element 912 tapers to a point at apex 914. The apex 914 is separated from (or spaced apart from) the central bar section of the antenna element 922 by gap 924. The width of the gap may be selected based on ionization effects. If the gap is big, the voltage used may be higher in order to collect more electrons. However, too high a voltage can cause unwanted ionization. Resonance characteristics may also be considered when selecting the gap width.

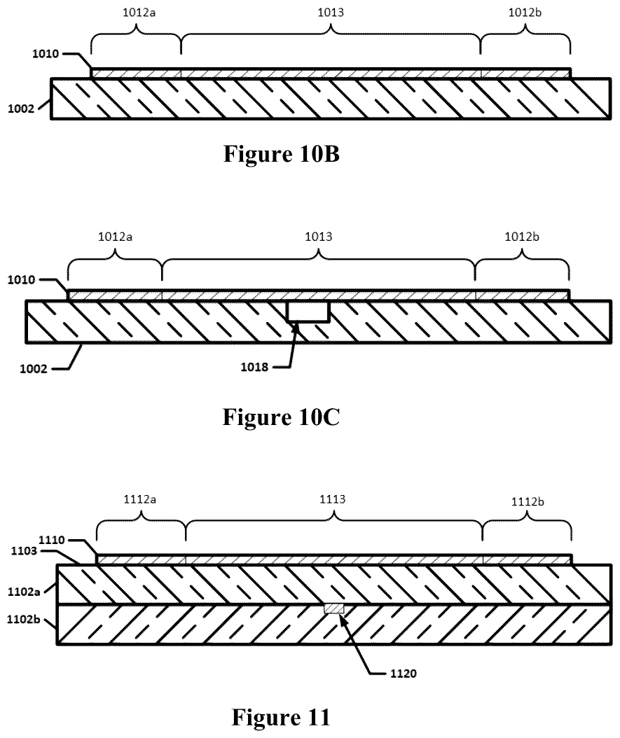

When the antenna element 922 absorbs optical energy, thermal heating occurs in the central bar section and thermionic emission (e.g., Schottky emission) may occur. The Schottky emissions are received by the collector element 912 and signals propagate along collector signal paths 930. Rotating elements can make them sensitive to different polarizations of light which allows detection of the polarization of the light received. Individual elements may be rotated based on the pattern created. For example, to provide antenna elements that are sensitive to different polarizations of light. In some embodiments, one or more of the plurality of antenna elements 922) (e.g., a subset of antenna elements 922) may be rotated 90° relative to other ones of antenna elements 922. This allows the detector chip 902 to detect polarity of the light detected. Referring now to FIGS. 10A-10C in which like elements are provided having like reference designations throughout the several views, in FIG. 10A shown is an alternate embodiment of an antenna-collector arrangement. In this example, diabolo antenna comprises two generally triangular shaped ends 1012a, 1012b (e.g., truncated triangular shapes) separated by central bar (or rectangular) section 1013. The diabolo antenna 1010 is disposed over a substrate 1002. A collector 1020 is disposed in proximity to a central region of the central bar section 1013 of the diabolo antenna 1010. The antenna-collector pair may optionally comprise an air bridge 1018.

The length (L) of the diabolo antenna 1010 along the central bar section 1013 may be selected to be resonant to a wavelength of interest. The length may be a fraction of the wavelength, λ, for example, λ/2, λ/4, etc. The width of the antenna ensures that optical energy received at the wavelength of interest generates heating in the bar section to produce Schottky emissions. Additionally, having the length equal to a fraction of the wavelength allows the antenna-collector pairs to make pixels that are compact (smaller than the wavelength of interest) and placed at a low pixel pitch (e.g., closely packed together).

As may be seen in FIG. 10B the antenna-collector arrangement 1000 is relatively planar. This approach allows for 2-dimensional layouts.

As noted above and as may be most clearly seen in FIG. 10C, in some embodiments, the central bar section 1013 of the diabolo antenna 1010 may be disposed over a void region (or gap) 1018 in substrate 1002 to thereby form an air bridge extending over gap 1018. The gap 1018 may help prevent thermal conductivity between the antenna and the underlying substrate.

FIG. 11 illustrates an alternate embodiment illustrating a vertically stacked diabolo antenna. As in the embodiments of FIGS. 10A-10C, the diabolo antenna 1110 features two substantially triangular shaped ends 1112a, 1112b separated by central bar section 1113. The width of the diabolo antenna 110 controls the choke of the diabolo antenna 1110. The size and shape of the triangular shaped ends 1112a, 1112b allow control of the resonance characteristics. Together, these attributes (or physical characteristics) contribute to the resonance (the bandwidth and the center wavelength).

Antenna 1110 is disposed over a first surface 1103 of a first substrate 1102a. A collector (which may be the same as or similar to any of the collectors described herein) is disposed between (or “sandwiched between”) a second opposing surface of the first substrate 1102a and a first surface of a second substrate 1102b. That is, in this example embodiment, collector 1120 is sandwiched between first and second substrates 1102a 1102b. Schottky emissions from the diabolo antenna 1110 can propagate through substrate 1102a and be received at the collector 1120. This design allows for a compact layout suitable for a dense array of antennas.

In some embodiments, substrate 1102a may be transparent to signals (i.e., light emissions) at wavelengths of interest. In such embodiments, collector 1120 may be disposed over the first surface 1103 of the first substrate 1102a and antenna 1010 (which may be the same as or similar to any of the antennas described herein) may be disposed between (or “sandwiched between”) the second first surface of the first substrate 1102a and a first surface of a second substrate 1102b. That is, in such embodiments, antenna 1010 is sandwiched between first and second substrates 1102a 1102b. Schottky emissions from the diabolo antenna 1110 can propagate through substrate 1102a and be received at the collector 1120.

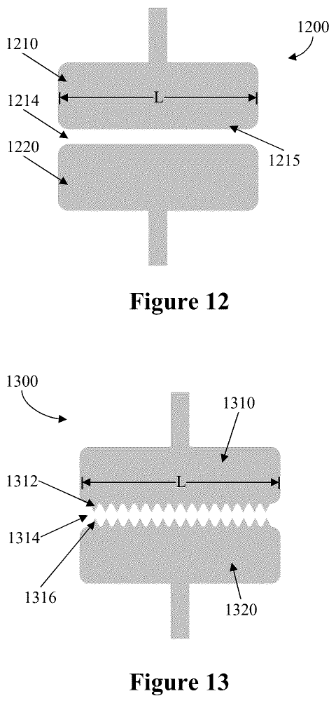

FIGS. 12-15 demonstrate various antenna-collector designs. As discussed above, the antenna may be provided having a variety of different shapes (including, but not limited to diabolo or triangular shapes). Additional shapes and designs are possible as well. The shapes of the various antenna elements may be selected to influence current flow, wavelength detection ranges, etc. These antennas may be on the size of micrometers or they may be nanoantennas.

FIG. 12 shows a first design 1200, where the antenna 1210 and the collector 1220 are rectangularly shaped. The rectangular shape is such that the length L of the antenna and collector along their adjacent sides is the larger side. As noted above, the length of antenna L is selected to be resonant at a wavelength of interest. A gap 1214 separates the antenna 1210 and the collector 1220. The gap 1214 may be 1 nm to 500 nm and can depend on the design and packaging considerations. However, larger gaps, e.g., greater than 500 nm, may be used with better vacuum states. In this embodiment, thermal heating may occur near the center of edge 1215 of the antenna 1210.

FIG. 13 shows another design 1300 where the antenna 1310 and the collector 1320 share matching saw-tooth features 1312, 1316. The saw-tooth feature 1312, 1316 can avoid the usage of a voltage bias and may provide resonance so as to select specific light detection characteristics. A gap 1314 separates the antenna 1310 and the collector 1320. The apexes of the saw-tooth features 1312, 1316 are located in close proximity. The gap 1314 may be 1 nm to 500 nm. In this embodiment, thermal heating may occur near the apexes of the saw-tooth features 1312 of the antenna 1210.

In another embodiment, a saw-tooth antenna element may be used with a rectangular collector. The current flow may be controlled with the various characteristics of the shapes (e.g., antenna width, etc.) and a bias voltage.

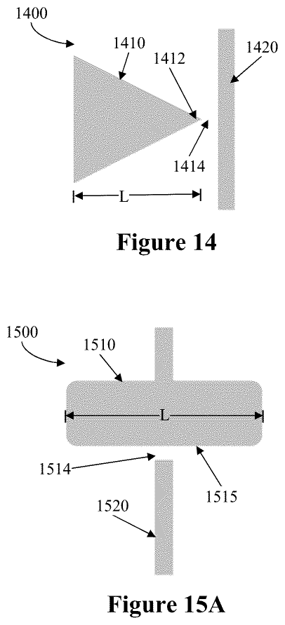

FIG. 14 shows a further design 1400. The antenna 1410 has a triangular shape with the apex 1412 located in proximity to the bar collector 1420. A gap 1414 separates the antenna 1410 and the collector 1420. In this embodiment, thermal heating may occur near the apex 1412 of the antenna 1410. In this design, the resonant length may be the distance from the apex 1412 to the opposite side In other designs, a large body and a sharp point can also work as an antenna (for example, the saw-tooth shapes of antenna 1310).

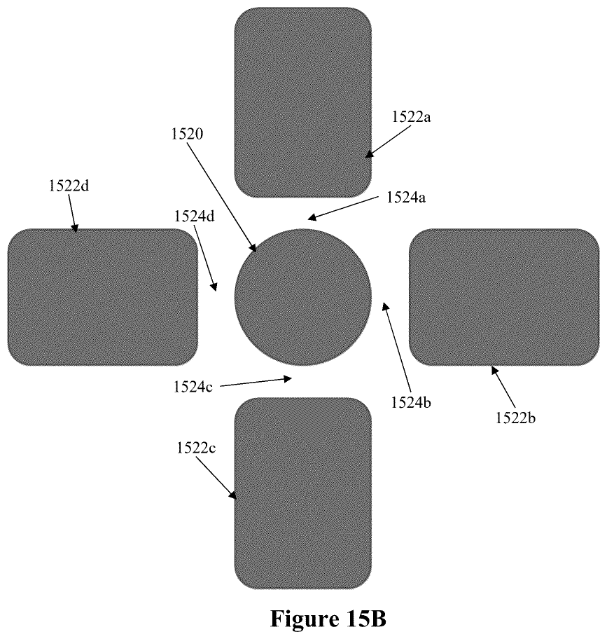

FIG. 15A shows an additional design 1500. The antenna 1510 is rectangularly shaped. A gap 1514 separates the antenna 1510 and the collector 1420. In this embodiment, thermal heating may occur near the center of edge 1515 of the antenna 1510.

FIG. 15B shows an alternate embodiment in which the number of collectors and the number of antennas differ depending upon the needs of a particular application. For example, in the embodiment of FIG. 15B a single antenna (or emitter) 1520 has a plurality of collectors (here, four (4) collectors 1522a-1522d) disposed thereabout. Collectors 1522a-1522d are spaced apart from (or separated from) and antenna 1520 by respective ones of gaps 1524a-1524d. In this example embodiment, antenna 1520 is circularly shaped and thermal heating occurs near the edge regions of the antenna 1520 to produce thermionic emissions from the antenna while the collectors are rectangularly shaped. It should, of course, be appreciated that in other embodiments, the antenna and collectors may be provided having any of the various shapes described herein. After reading the description provided herein, one of ordinary skill in the art will appreciate how to select the number and shapes of antennas and collectors to suit the needs of a particular application.

The collectors 1522a, 1522c are arranged (or oriented) to receive signals emitted from antenna 1520 having a first polarization and antennas 1522b, 1522d are arranged (or oriented) to receive signals emitted from antenna 1520 having a second different polarization. In embodiments the collectors may be arranged to receive signals having orthogonal polarizations. In embodiments, collectors 1522a, 1522c may be arranged to receive signal having a vertical polarization and antennas 1522b, 1522d are arranged to receive signal having a horizontal polarization. Such an embodiment (e.g., an embodiment in which collectors are arranged to receive signals having different polarizations) may be desirable in applications in which polarization sensitivity is desired.

It should also be appreciated that although a single emitter 1520 is illustrated in FIG. 15B, other embodiments may include multiple emitters (e.g., two or more emitters) and multiple collectors (e.g., two or more collectors) where the number of antennas is different than the number of collectors. Alternatively still, some embodiments may include multiple emitters and a single collector.

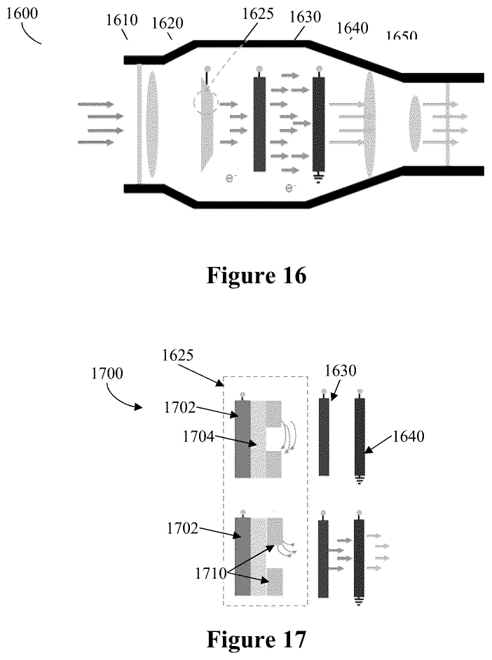

FIG. 16 illustrates a device 1600 for light detection in accordance with an embodiment. IR photons enter the device 1600 and are focused by a lens 1610. The photons encounter nanoantennas 1620, where photons are converted to electrons due to Schottky emissions. Antennas 1620 may be any of the designs described herein. The electrons are collected by a microchannel plate 1630 is a electron multiplier and is used for amplifying the electrons. A phosphor plate 1640 receives the multiplied electrons and converts them to photons, which are collimated by lenses 1650 and exit on the right where they may be seen directly or captured. The phosphor plate 1640 may be a scintillator like Ce:YAG.

The device 1600 operates in a similar fashion to traditional night-vision devices work. However, in contrast to a conventional photocathode, the device 1600 uses antennas in accordance with various embodiments whose spectral, polarization, etc. sensitivity can be tuned.

FIG. 17 illustrates the impact of a bias voltage to an antenna 1620 at point 1625. The antenna 1620 includes a doped semiconductor layer 1702 and a dielectric layer 1704. On top of the dielectric layer is an antenna 1710. When a bias (or negative) voltage is applied to the semiconductor layer 1702, for example, from (bottom), the electrons are forced towards the microchannel plate 1630 and, as described above, multiplied and converted to photons by the phosphor plate 1640.

The substrate (the doped semiconductor layer 1702 and the dielectric layer 1704) may be transparent to the light which is used to generate electrons and exhibits a high breakdown voltage. Antenna 1620 may be seen as a cross-sectional view of the designs 1200, 1300, 1400, 1500.

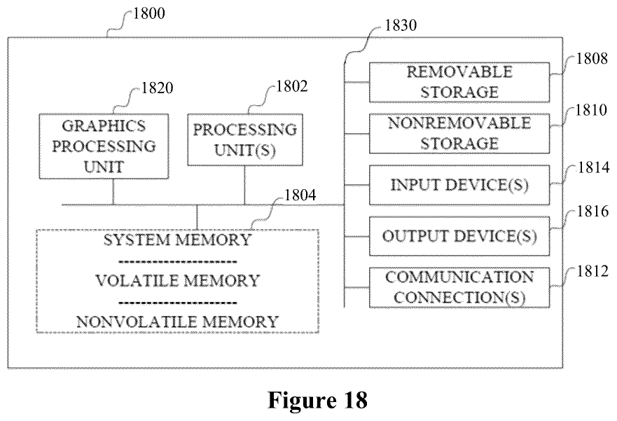

FIG. 18 a block diagram of a general-purpose computer 1800 which processes computer programs using a processing system. The computer 1800 comprises a processing system including at least one processing unit 1802 and a memory 1804. The computer 1800 can have multiple processing units 1802 and multiple devices implementing the memory 1804. A processing unit 1802 can include one or more processing cores (not shown) that operate independently of each other. Additional co-processing units, such as graphics processing unit 1820, also can be present in the computer 1800.

The memory 1804 may include volatile devices (such as dynamic random-access memory (DRAM) or other random-access memory device), and non-volatile devices (such as a read-only memory, flash memory, and the like) or some combination of the two, and optionally including any memory available in a processing device. Other memory such as dedicated memory or registers also can reside in a processing unit. Such a memory configuration is delineated by the dashed line 1804 in FIG. 18.

The computer 1800 may include additional storage (removable and/or non-removable) including, but not limited to, solid state devices, or magnetically recorded or optically recorded disks or tape. Such additional storage is illustrated in FIG. 18 by removable storage 1808 and non-removable storage 1810. The various components in FIG. 18 are generally interconnected by an interconnection mechanism, such as one or more buses 1830.

A computer storage medium is any medium in which data can be stored in and retrieved from addressable physical storage locations by the computer. Computer storage media includes volatile and nonvolatile memory devices, and removable and non-removable storage devices. Memory 1804, removable storage 1808 and non-removable storage 1810 are examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices.

The computer 1800 may also include communications connection(s) 1812 that allow the computer 1800 to communicate with other devices over a communication medium. Communication media typically transmit computer program code, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media include any non-wired communication media that allows propagation of signals, such as acoustic, electromagnetic, electrical, optical, infrared, radio frequency and other signals. Communications connections 1812 are devices, such as a network interface or radio transmitter, that interface with the communication media to transmit data over and receive data from signals propagated through communication media.

The communications connections can include one or more radio transmitters for telephonic communications over cellular telephone networks, and/or a wireless communication interface for wireless connection to a computer network. For example, a cellular connection, a Wi-Fi connection, a Bluetooth connection, and other connections may be present in the computer 1800. Such connections support communication with other devices, such as to support voice or data communications.

The computer 1800 may have various input device(s) 1814 such as various pointer (whether single pointer or multi-pointer) devices, such as a mouse, tablet and pen, touchpad and other touch-based input devices, stylus, image input devices, such as still and motion cameras, audio input devices, such as a microphone. The computer 1800 may have various output device(s) 1816 such as a display, speakers, printers, and so on, also may be included.

The various storage 1810, communication connections 1812, output devices 1816 and input devices 1814 can be integrated within a housing of the computer 1800 or can be connected through various input/output interface devices on the computer 1800, in which case the reference numbers 1810, 1812, 1814 and 1816 can indicate either the interface for connection to a device or the device itself as the case may be.

An operating system of the computer 1800 typically includes computer programs, commonly called drivers, which manage access to the various storage 1810, communication connections 1812, output devices 1816 and input devices 1814. Such access generally includes managing inputs from and outputs to these devices. In the case of communication connections, the operating system also may include one or more computer programs for implementing communication protocols used to communicate information between computers and devices through the communication connections 1812.

As described above, various embodiments provide a method and apparatus to detect light.

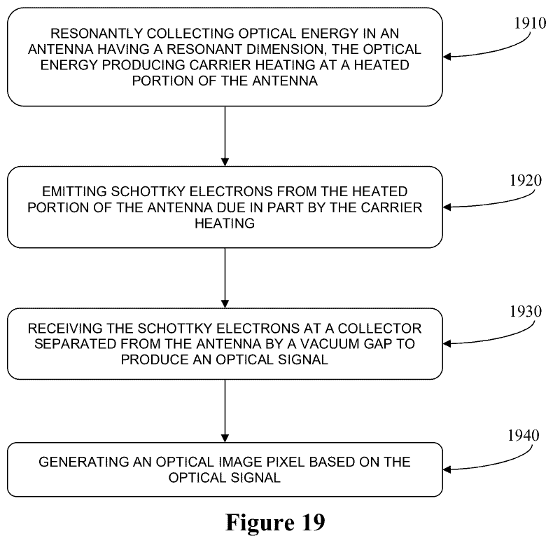

FIG. 19 is a logic flow diagram that illustrates a method, and a result of execution of computer program instructions, in accordance with various embodiments. In accordance with an embodiment a method performs, at Block 1910, a step of resonantly collecting optical energy in an antenna configured to absorb energy from photons having a desired wavelength. A resonant dimension of the antenna is a resonant length based on the desired wavelength. The resonant dimension is configured to cause the energy absorbed to heat a heated portion of the antenna and cause the antenna to emit a Schottky emission. The optical energy produces the carrier heating at the heated portion. At Block 1920, Schottky electrons are emitted from the heated portion of the antenna due in part by the carrier heating. The Schottky electrons are received at a collector separated from the antenna by a vacuum gap to produce an optical signal at Block 1930. The method performs, at Block 1940, a step of generating an optical image pixel based on the optical signal.

The various blocks shown in FIG. 19 may be viewed as method steps, as operations that result from use of computer program code, and/or as one or more logic circuit elements constructed to carry out the associated function(s).

One embodiment provides a device for converting mid-wave infrared radiation (MWIR) into an electron current emission. The device includes a doped semiconductor; a dielectric material; and a nanoantenna for emitting Schottky electrons in response to MWIR.

In one embodiment of the disclosed device, the nanoantenna has a bias voltage by reference to the semiconductor.

In one embodiment of the disclosed device, the nanoantenna includes a metal selected from Au, TiN, Al, and Mo.

In one embodiment of the disclosed device, the nanoantenna consists of a triangular shape having a tip apex, and a highly localized electric field at the tip apex.

In one embodiment of the disclosed device, the MWIR includes 3-5 μm frequency.

Another embodiment provides a system including the disclosed device.

In one embodiment, the disclosed system further includes a full-field imaging detector.

In one embodiment of the disclosed system, the detector includes multichannel plates and phosphor screen.

In one embodiment of the disclosed system, the detector includes a photodiode that has <100 ns timing resolution.

In one embodiment, the disclosed system further includes lenses for optical imaging.

In one embodiment of the disclosed system, the system operates at room (ambient) temperature.

In one embodiment of the disclosed system, detectivities are greater than 10⁸ Jones, 10⁹ Jones, or 10¹⁰ Jones.

In one embodiment of the disclosed system, the bandwidth is greater than 10⁵ Hz, 10⁶ Hz, 10⁷ Hz, 10⁸ Hz, 10⁹ Hz, or 10¹⁰ Hz.

In one embodiment, the disclosed system further includes an IREEN-based detector.

A further embodiment provides a method of using the disclosed system. The method converts a MWIR signal to an optical image.

In one embodiment of the disclosed method, the optical image is captured digitally.

Another embodiment provides a computer system for producing an optical image, including a processing system and computer storage accessible to the processing system. The computer system also includes computer program instructions encoded on the computer storage. When the computer program instructions are processed by the processing system, the computer system is configured to define data structures in the computer storage representing the MWIR signal received by the disclosed system; and execute a program applied to the data structures to produce an optical image representing the MWIR.

In one embodiment of the disclosed computer system, the computer continuously streams MWIR signals into optical images.

A further embodiment provides a computer program product comprising computer storage and computer program instructions encoded on the computer storage, wherein the computer program instructions, when processed by a processing system of a computer, causes the computer to perform the disclosed method or implement the disclosed computer system.

Various embodiments of the concepts, systems, devices, structures and techniques sought to be protected are described. It should, however, be appreciated that alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, e.g., one, two, three, four, etc. The terms “a plurality” are understood to include any integer number greater than or equal to two, e.g., two, three, four, five, etc. The term “connection” can include an indirect “connection” and a direct “connection”.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A device for converting light into an electron current emission, the device comprising a substrate having first and second opposing surfaces;
at least one antenna disposed on the substrate, the at least one antenna configured to absorb energy from photons having a selected wavelength, wherein at least one dimension of the at least one antenna is a resonant length based on the selected wavelength, wherein in response to photons incident thereon at least a portion of the at least one antenna is heated to a degree which results in a thermionic emission from the at least one antenna; and
at least one collector spaced apart from the at least one antenna by a selected distance, the at least one collector configured to receive a Schottky emission from the at least one antenna.

2. The device of claim 1 further comprising an output configured to produce a signal in response to the at least one collector receiving the thermionic emission.

3. The device of claim 1 wherein the thermionic emission is a Schottky emission.

4. The device of claim 1 wherein at least one of the at least one antenna has a shape corresponding to one of:
(a) a rectangular shape;
(b) a square shape;
(c) a triangular shape; and
(d) a diabolo shape.

5. The device of claim 1 wherein at least one of the at least one collectors has a shape corresponding to one of:
(a) a rectangular shape;
(b) a square shape;
(c) a triangular shape;
(d) a saw tooth shape; and
(e) a diabolo shape.

6. The device of claim 1 wherein the shape of at least one antenna matches the shape of at least one collector.

7. The device of claim 1 wherein the at least one antenna is provided as an array of antennas with each antenna of the array of antennas coupled to one collector.

8. The device of claim 1 wherein the at least one collector is provided as an array of collectors.

9. The device of claim 1 wherein:
the at least one antenna is provided as an array of antennas;
the at least one collector is provided as an array of collectors; and
each antenna of the array of antennas is coupled to a corresponding antenna of the array of antennas.

10. The device of claim 1 wherein the portion of the at least one antenna which is heated occurs at an apex region of the at least one antenna.

11. The device of claim 1 wherein the at least one antenna has a diabolo shape and the portion of the at least one antenna which is heated occurs at a bar region of the diabolo-shaped antenna.

12. The device of claim 1, wherein the at least one antenna and at least one collector comprise materials are selected to reduce a thermal conductance characteristic between the at least one antenna and the substrate.

13. A device as in claim 1, wherein the at least one antenna and/or the at least one collector are disposed on the substrate such that at least a portion of at least one of the antenna and collector is partially or wholly suspended so as to prevent thermal conductivity between the at least one antenna and the underlying substrate.

14. A sensor system comprising:
a device for converting light into an electron current emission comprising:
a substrate having first and second opposing surfaces;
at least one antenna disposed on the substrate, the at least one antenna configured to absorb energy from photons having a selected wavelength, wherein at least one dimension of the at least one antenna is a resonant length based on the selected wavelength, wherein in response to photons incident thereon at least a portion of the at least one antenna is heated to a degree which results in a thermionic emission from the antenna; and
at least one collector spaced apart from the at least one antenna by a selected distance, the at least one collector configured to receive a Schottky emission from the at least one antenna and generate the electron current emission;
a processor configured to receive the electron current emission and generate an output signal; and
an output device configured to produce an image based on the output signal.

15. The sensor system of claim 14, where the device for converting light into an electron current emission is partially or wholly suspended so as to prevent thermal conductivity between the at least one antenna and the underlying substrate.

16. The sensor system of claim 14, wherein when generating the output signal, the processor is configured to generate a pixel based on the electron current emission received from the device for converting light into an electron current emission.

17. The sensor system of claim 14, wherein the processor configured to receive the electron current emission from a plurality of devices for converting light into an electron current emission.

18. A method comprising:
resonantly collecting optical energy in an antenna configured to absorb energy from photons having a desired wavelength, wherein a resonant dimension of the antenna is a resonant length based on the desired wavelength, wherein the resonant dimension is configured to cause the energy absorbed to heat a heated portion of the antenna and cause the antenna to emit a Schottky emission, the optical energy producing carrier heating at the heated portion;
emitting Schottky electrons from the heated portion of the antenna due in part by the carrier heating;
receiving the Schottky electrons at a collector separated from the antenna by a vacuum gap to produce an optical signal; and
generating an optical image pixel based on the optical signal.
